(19) United States
(12) Patent Application Publication
(10) Pub. No.: US 2002/0010975 A1
(43) Pub. Date: Jan. 31, 2002

(54) Forearm support for paint applicator

(76) Inventors: Michael J. Walsh, Elm Grove, WI (US); Brian E. Woodnorth, Whitefish Bay, WI (US); Todd R. Niemuth, Oostburg, WI (US)

Correspondence Address: Scott D. Anderson, FOLEY & LARDNER, Firstar Center, 777 East Wisconsin Avenue, Milwaukee, WI, 53202-5367, US

(21) Appl. No.: 09/823,067

(22) Filed: Mar. 30, 2001

Related U.S. Application Data
(60) Provisional application No. 60/193,219, filed on Mar. 30, 2000.

(51) Int. Cl. B05C 17/02; A46B 5/02

(52) U.S. Cl. 15/230.11; 15/143.1; 15/144.4

(57) ABSTRACT

A paint applicator is disclosed. The paint applicator comprises an applicator frame, an applying medium coupled to the applicator frame, and a support coupled to the frame adapted to fit against a forearm of a user

### CROSS REFERENCE TO RELATED APPLICATIONS

The present invention claims prior under 35 U.S.C. § 119 from U.S. Provisional Patent Application No. 60/193,219 titled “Paint Accessories” filed Mar. 30, 2000 (Attorney Docket No. 62759-341), the full disclosure of which is hereby incorporated by reference.

### FIELD OF THE INVENTION

The present invention relates to a forearm support for paint applicator.

### BACKGROUND OF THE INVENTION

It is generally known to provide for a paint applicator such as a paint roller or paint brush. Such paint applicators typically include a handle, a frame, and an paint applying member.

Use of such known paint applicators typically requires extensive use of hand, wrist, and forearm muscles. However, such use of known paint applicators tends to cause fatigue in the user's hand, wrist, and forearm muscles, particularly when the paint applicator is used over an extended period of time or when above normal force is exerted on paint applying medium to transfer paint (e.g., for a textured surface).

Accordingly, there is a present need for a forearm support for a paint applicator. There is also a present need for a forearm support that moves between a deployed position and a stowed position.

### SUMMARY OF THE INVENTION

The present invention relates to a paint applicator. The paint applicator comprises an applicator frame, an applying medium coupled to the applicator frame, and a support coupled to the frame adapted to fit against a forearm of a user.

The present invention also relates to a paint applicator. The paint applicator comprises an applying medium coupled to an applicator frame, and a support coupled to the frame wherein the support is adapted to fit against a forearm of a user and is configured to be moved between a first position and a second position.

The present invention further relates to a paint applicator. The paint applicator comprises an applicator frame, an applying medium coupled to the applicator frame, a support means for leveraging against a forearm of a user, a hinge mechanism coupling the support to the handle and configured move the support between a first position and a second position.

### BRIEF DESCRIPTION OF THE DRAWINGS

FIG. 1 is a perspective view of a paint applicator according to an exemplary embodiment.

FIG. 2 is a side elevation view of the paint applicator of FIG. 1.

FIG. 3 is a fragmentary side elevation view of a hinge mechanism of the paint applicator of FIG. 2.

FIG. 4 is a sectional view of FIG. 3 taken along lines 4-4.

FIG. 5 is a perspective view of a first embodiment of the paint applicator of FIG. 1.

FIG. 6 is a perspective view of a second embodiment of the paint applicator of FIG. 1 in a deployed position

FIG. 7 is a perspective view of the paint applicator of FIG. 6 in a stowed position.

FIG. 8 is a fragmentary perspective view of a hinge mechanism of the paint applicator of FIG. 6.

### DETAILED DESCRIPTION OF PREFERRED AND OTHER EXEMPLARY EMBODIMENTS

The following description of the preferred embodiments is merely exemplary in nature and is in no way intended to limit the invention, or its application, or uses.

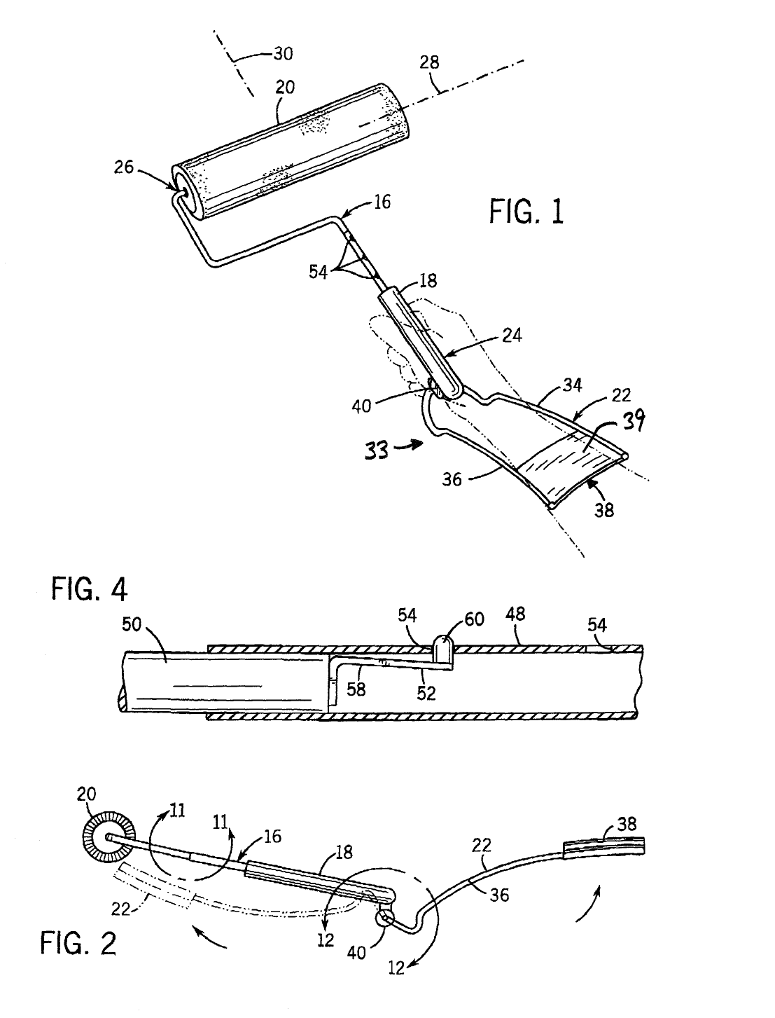

FIG. 1 is a perspective view of a paint applicator (shown as a paint roller 10) generally including a frame 16 having a handle 18, a paint applying member 20, and a leverage cantilever support (shown as a forearm support 22). Frame 16 is an elongate member having multi-bends intended to provide a desired functional and aesthetic configuration. Frame 16 has a proximal end 24 closest to the user upon which handle 18 is formed attached, and is situated equi-distantly between axial ends of member 20. Frame 16 has a distal end 26 upon which paint applying member 20 is supported.

According to a preferred embodiment, paint applying member 20 includes at least one cage rotatably coupled to frame 16 for rotation about an axis 28 for roller application of paint. The cage may be made from any of a variety of materials (e.g., plastic, metal, etc.). According to a particularly preferred embodiment, the cage is formed from a thermoplastic material such as described in co-pending U.S. patent application Ser. No. 08/767,580, the full disclosure of which is hereby incorporated by reference. Each cage is configured to be press fit into the core of a roller cover carrying a paint applying medium such as fabric, foam or sponge material. Although illustrated as a generally patternless, non-embossed outer cylindrical surface, member 20 may alternatively include any of a variety of embossed or otherwise patterned outer circumferential surface. According to an exemplary embodiment, member 20 may include a single member in lieu of the roller cover and cage combination. According to alternative embodiments, roller 10 may include a plurality of members 20 spaced along axis 28. According to other alternative embodiments, the paint applying medium is configured to apply paint in any of a variety of conventional methods, mediums, configurations, etc.

Forearm support 22 extends from handle 18 and generally includes a frame 33 having bars or arms 34, 36, and a forearm engagement surface 38. Arms 34, 36 extend from handle 18 to a point above the plane containing handle 18 and axis 28 about which paint applying member 20 rotates. Arms 34, 36 diverge away from one another or extend at spaced locations relative to one another a sufficient distance to receive the wrist and lower forearm of the user's arm. By angling arms 34, 36 from one another, it is intended to better conform and receive the user's forearm, and to improve storage capacity when forearm support 22 is in the stowed position. According to a preferred embodiment, arms 34, 36 are configured to flex when pressure is applied (e.g., during use). Flexing of arms 34, 36 during use is intended to cause engagement 38 surface to conform around the user's arm. In another alternative embodiment, the arms may be parallel to one another. According to an alternative embodiment, the frame may be comprised of tubes, a single curvalinear member, or the like. Forearm support 22 may be made from any of a variety of materials (e.g., metal, alloys, plastic, etc.), and formed by any of a variety of manufacturing techniques.

Forearm engagement surface 38 extends between arms 34, 36 and is configured to engage in contact with an upper portion of the user's forearm. According to a preferred embodiment, forearm support surface 38 is provided by a flexible band or sheathing 39 (e.g., fabric, plastic, elastomer, natural or synthetic rubber, vinyl, etc.) extending relatively taut between arms 34 and 36. Such flexible band or sheathing 39 is intended to conform to the forearm of a variety of potential users. According to an alternative embodiment, the forearm engagement surface may be a web, a single curvalinear or straight bar or arm, panel, or the like. Alternatively forearm support 22 may include a strap configured to wrap around the user's wrist or forearm an is intended to provide increased control of applicator 10. Forearm engagement surface 38 may have a radius of between 1 inch and 6 inches. According to a preferred embodiment, forearm engagement surface 38 has a radius of about 3.5 inches. According to alternative embodiments, the forearm engagement surface may have any of a variety of radii configured to generally conform to a user's forearm. Alternatively, the engagement surface may be generally planar or have other shapes and/or configurations. Forearm support surface 38 may alternatively be provided by a rigid structure or material configured to comfortably fit against the user's forearm.

As best shown by FIG. 1, the user inserts his or her hand between arms 34, 36 and grasps handle 18 with forearm support surface 38 resting against an upper portion of the user's forearm. During the application of paint or other liquid, forces are transmitted to the user's forearm. As a result, forearm support 22 lessens the amount of stress upon the user's wrist, which is intended to reduce fatigue during prolonged periods of use of roller 10.

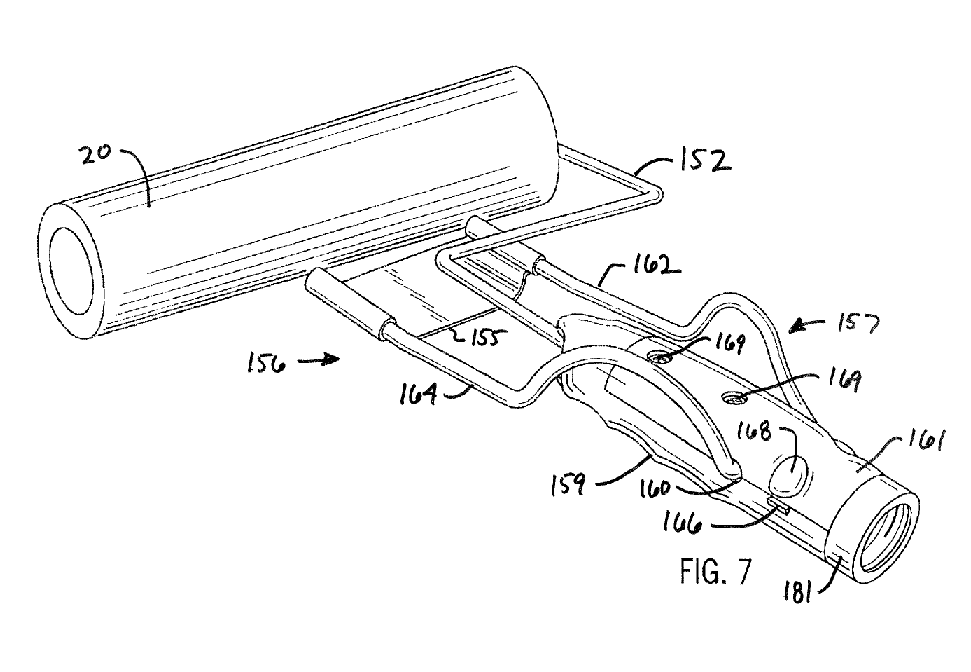

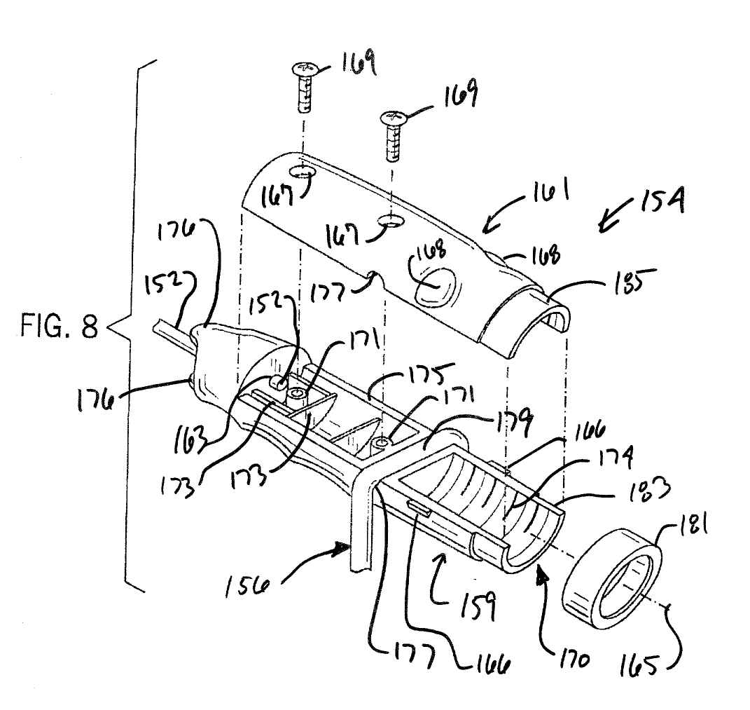

According to an exemplary embodiment, forearm support 22 is configured to move between a stowed (e.g., collapsed, retracted, folded, etc.) position (FIGS. 2, 7) and a deployed (e.g., extended, unfolded, etc.) position (FIGS. 1, 2, 3, 5, 6). According to a preferred embodiment, forearm support 22 is configured to pivot or rotate between the stowed and deployed positions. Forearm support 22 is configured to pivot between 130° and 160°. According to a preferred embodiment, forearm support 22 is configured to pivot about 145°. According to alternative embodiments, the forearm support may be configured to pivot any of a variety of ranges of angles or distances between its deployed and stowed positions. Forearm support 22 may be between 4 inches and 12 inches. According to a preferred embodiment, forearm support 22 is approximately 8.5 inches. According to alternative embodiments, the forearm support may have any of a variety of lengths that provide support for the paint applicator. Distance between arms 34, 36 may be between 2 inches and 5 inches. According to a preferred embodiment, the distance between arms 34, 36 is about 3.25 inches. According to an alternative embodiment, the distance between the arms may be any of a variety of dimensions configured to allow the user to insert his or her hand to grip handle 18.

According to a preferred embodiment, forearm support 22 is pivotably coupled to handle 18 by pivotal coupling (shown as a hinge mechanism 40) so that forearm support 22 may be collapsed or folded for ease of storage or display. Alternatively, forearm support 22 is slidably coupled to handle 18 (e.g., ends of arms 34, 36 slidably engaged with a slot or groove in handle 18, or the like). In yet another alternative embodiment, forearm support 22 may be removably attached to handle 18 so that forearm support 22 may be detached from handle 18 when not in use (e.g., for storage, cleaning, use of applicator without forearm support 22, repair or replacement, etc.). Although less desirable, forearm support 22 may alternatively be rigidly attached to handle 18. In such alternative embodiment, forearm support 22 is not configured to move to a retracted position (e.g., fixedly coupled to handle 18 in the orientation shown in FIG. 1).

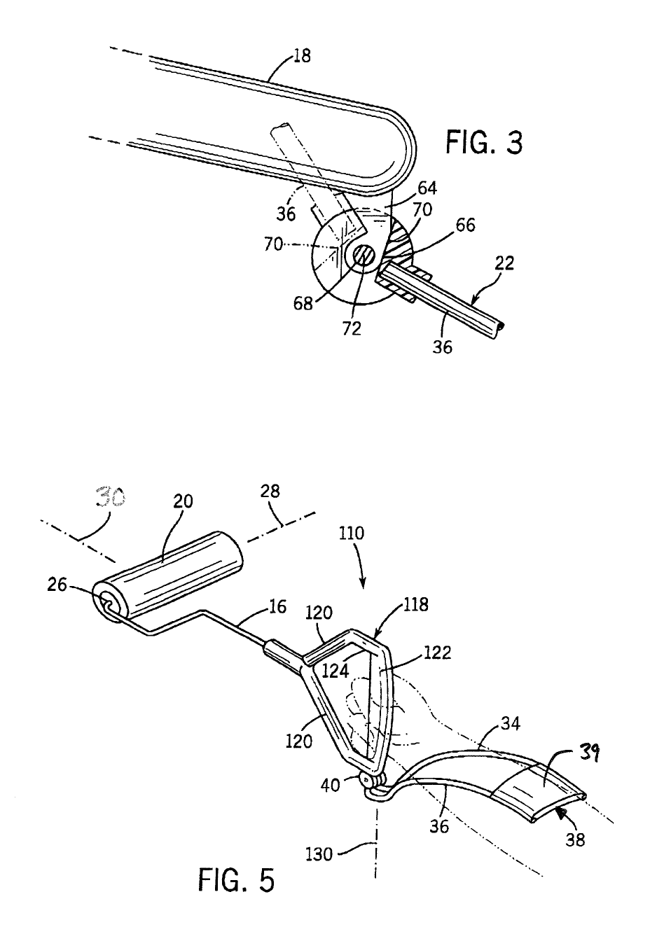

FIG. 3 illustrates hinge mechanism 40 in greater detail. Hinge mechanism 40 includes a bracket (shown as ears 64), a pivot member 66, and a pivot pin 68. Ears 64 extend from frame 16 or handle 18 on opposite sides of pivot member 66. Pivot pin 68 extends through pivot member 66 and is journaled to each of ears 64. Pivot member 66 is secured to arms 34, 36 (shown in FIG. 1). Pivot member 66 includes a stop surface 70 which extends so as to engage ears 64 to prevent further rotation of pivot member 66 when forearm support 22 has been pivoted to the extended position (shown in solid lines). The rotation of forearm support 22 in the clockwise direction (shown in FIG. 2) pivots forearm support 22 to the collapsed or folded position shown in phantom. As will be appreciated, hinge mechanism 40 may comprise a variety of alternative pivoting structures which would enable forearm support 22 to pivot relative to handle 18.

According to an exemplary embodiment shown in FIG. 4, frame 16 is configured to be telescopically adjustable along axis 30 to enable the user to reach otherwise inaccessible or unreachable walls or surfaces for painting Frame 16 includes outer tube 48, inner tube 50 and push pin mechanism 52.

Outer tube 48 extends forwardly from handle 18 (shown in FIG. 1) and is generally hollow so as to receive inner tube 50. Outer tube 48 further includes a plurality of axially spaced radially extending openings 54 sized to receive a portion of push pin mechanism 52.

Inner tube 50 comprises an elongate tube or shaft telescopically received within outer tube 48. Inner tube 50 forms distal end 26 of frame 16. Inner tube 50 is coupled to push pin mechanism 52.

Push pin mechanism 52 is fixedly secured to inner tube 50 by adhesives, welding and the like and generally includes spring member 58 and pin 60. Spring 58 resiliently biases pin 60 towards and through a selected one of openings 54. Pin 60 extends from spring 58 and engages outer tube 48 when pin 60 extends through outer tube 48 to releasably retain inner tube 50 at any one of a variety of positions along outer tube 48. Pin 60 moves between a retracted position against the force of spring 58 whereby tubes 50 and 48 telescopically move relative to one another and an extended position in which pin 60 projects through a selected window opening 54. As will be appreciated, the relationship between outer tube 48 and inner tube 50 may be reversed, wherein inner tube 50 extends from handle 18 and wherein outer tube 48 forms a distal end 26 of frame 16. Alternatively, push pin mechanism 52 may be coupled to outer tube 48. According to other alternative embodiments, the tubes may have any of a variety of configurations and mechanisms configured to provide adjustable and/or selective extension or retraction (e.g., telescoping). The spring may be made of any of a variety of metals or metal alloys. According to a preferred embodiment, the spring is made from metal or metal alloys. Alternatively, the spring may be made from any of a variety of materials configured to store and release mechanical energy and/or provide a bias, and in any of a variety of configurations (e.g., coil, spiral, etc.).

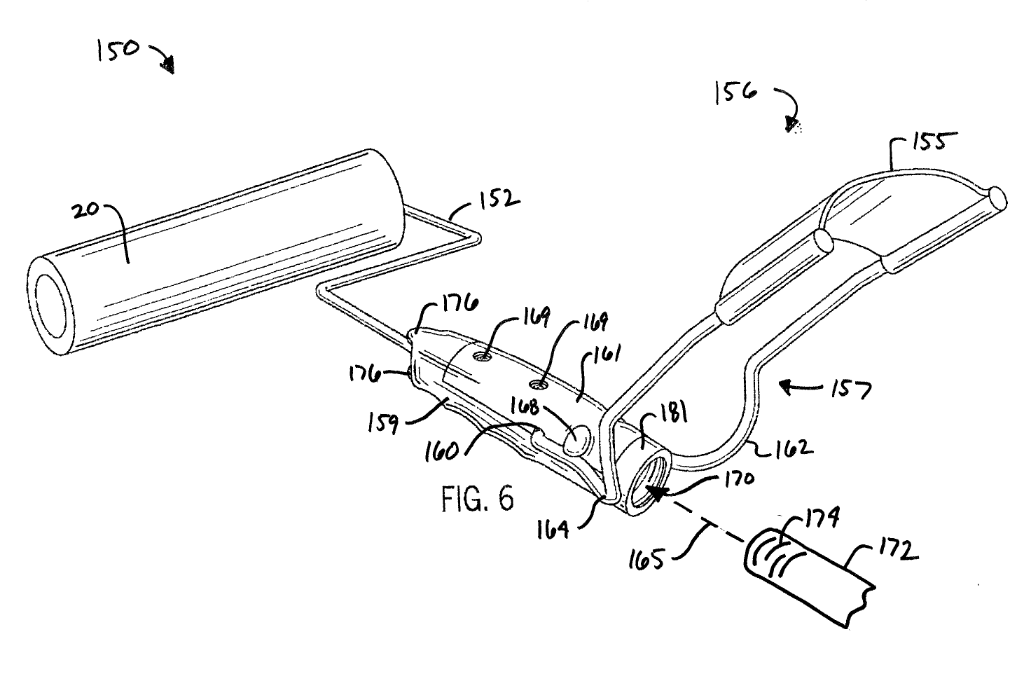

FIG. 5 illustrates paint roller 110, a first alternative embodiment of paint roller 10 shown in FIG. 1. Paint roller 110 is substantially similar to paint roller 10 except that paint roller 110 includes handle 118 in lieu of handle 18. Those remaining components of roller 110 which correspond to similar elements of roller 10 are numbered similarly. Handle 118 includes a generally Y-shaped pair of legs 120 interconnected by a grip 122. Legs 120 and grip 122 extend in a single plane and define an opening 124 large enough to receive the user's finger as the user grips grip 122. Grip 122 generally extends along axis 126 which itself extends perpendicular to axis 28 and perpendicular to axis 130. Grip 122 is configured to be grasped by the user's hands between the user's fingers and thumb. In one alternative embodiment, grip 122 extends along an alternative axis that is parallel to axis 28 yet perpendicular to axis 130. In such an alternative embodiment, arms 34, 36 would be pivotably coupled to opposite ends of grip 122. In one alternative embodiment, frame 16 is rotatably journaled to handle 18 or the end of handle 118 for rotation about axis 30. As a result, rolling paint applying member 20 also swivels or rotates about axis 30 to accommodate various wall angles and to allow for hand repositioning to reduce fatigue. In such an alternative embodiment, handle 18 or handle 118 is preferably configured with a locking mechanism such as a collar which may be selectively tightened or clamped about the adjacent end of frame 16 to selectively prevent rotation of frame 16 about axis 30 or may be loosened to allow rotation of frame 16.

According to alternative embodiments, the handle may have a variety of configurations configured to provide improved performance, leverage, ergonomics, and the like. For example, the handle may have a curved surface (e.g., bulbous, semi-spherical, etc.) which is gripped by the hand and fits into the users palm. Alternatively, the handle may be T-shaped wherein the grip is generally perpendicular to conventional handle arrangements.

FIGS. 6 and 7 illustrate a paint applicator 150, a second alternative embodiment of paint roller 10. Applicator 150 includes an applicator frame 152 having a handle 154, and a rear portion (shown as a forearm support 156) pivotally coupled to handle 154 by a pivot mechanism 158.

Handle 154 is comprised of a pair of handle portions 159, 161, which may be held together with any of a variety of techniques (such as welding, adhesives, snap-fit engagements, fasteners e.g., screws, bolts, pins, etc.), and the like. According to a preferred embodiment, handle portions 159, 161 are coupled together by a pair of fasteners 169 (e.g., screws, bolts, pins, etc.) disposed in apertures 167 to engage a pair of hollow bosses 171 extending generally perpendicular to axis 165. Handle portion 159 includes a bore 163 aligned with an axis 165 and configured to securely receive applicator frame 152. Handle portion 159 and/or handle portion 161 may include one or more ribs 173 configured to provide reinforcement to outer wall 175. One or more hooks (shown as projections 176) may be provided on handle 154 to suspend or support applicator 150 (e.g., on a ladder, a work surface, a reservoir such as a paint can or pail, and the like).

Forearm support 156 includes a web 155 disposed between distal ends of a frame 157 having arms 162, 164 that engage a bore 160 in handle 154. Web 155 may be provided by a flexible band or sheathing 39 (e.g., fabric, plastic, elastomer, natural or synthetic rubber, vinyl, etc.). Alternatively, forearm aupport 156 may include a strap configured to wrap around the user's wrist or forearm and is intended to provide increased control of applicator 150. Bore 160 is provided by a pair of opposing notches 177. According to a preferred embodiment, a segment 179 of frame 157 is disposed (e.g., “captured”) by notch 177 of handle portion 159 and notch 177 of handle portion 161.

To pivot between the deployed position (FIG. 6), and the stowed position (FIG. 7), forearm support 156 pivots about bore 160 (e.g., at ends or arms 162, 164 or segment 179 of frame 157). Bore 160 may be configured (e.g., shaped, sized, etc.) to inhibit pivoting of forearm support 156 (e.g., under its own weight, etc.). According to an alternative embodiment, the handle includes a biasing mechanism configured to resist movement of the forearm support.

According to an alternative embodiment, support frame 157 includes distal ends of arms 162, 164 configured to be inserted into bore 160 which may be provided by openings in wall 175 (e.g., for a one-piece handle) rather than notches 177. As such, arms 162, 164 are configured to be removable from bore 160 in handle 154 (e.g., for storage, cleaning, use of applicator without forearm support 156, repair or replacement, etc.) by spreading (i.e., flexing) arms 162, 164 until ends are outside handle 154.

When forearm support 156 is pivoted to the deployed position, arms 162, 164 are held or secured in place by bumps 166, 168 (e.g., concave surfaces, ridges or the like) in a snap-fit type engagement. Bump 166 is configured (shaped, sized, etc.) to allow arms 162, 164 to pass over upon a slight flexing of arms 162, 164. Bump 168 is configured to prohibit additional pivoting of forearm support 156 (e.g., to prevent over-rotation). According to an alternative embodiment, handle 154 may include a groove and arms 162, 164 including a projection (e.g., tongue, bump, etc.) that engages the groove on the handle.

According to an exemplary embodiment, forearm support is biased between the stowed and the deployed positions (e.g., to adjust with movements of the user's arm during use). For example, a torsion spring may be placed in handle 154 such that applicator 150 would be able to rotate, but biased to a base position (e.g., centered) by the spring. Such an arrangement is intended to provide a less restrictive painting stance.

According to an exemplary embodiment, handle 154 includes a bore 170 opening at end of handle 154. Bore 170 is configured to receive an accessory 172 (e.g., post, stick, handle, etc.) to provide additional functionality and range. According to a preferred embodiment, bore 170 includes threads 174 to receive a threaded end of accessory 172. According to alternative embodiments, accessory 172 couples to handle 154 using any of a variety of techniques (e.g., snap fit, pins, mechanical fasteners, etc.). Accessory 172 may be any of a variety of articles and/or devices. According to an exemplary embodiment, accessory 172 may be an extension pole or ergonomic extension as described in U.S. patent application Ser. No. ______ titled “Paint Roller and Extension Pole” filed ______ (Attorney Docket No. 62759-335), the full disclosure of which is herein incorporated by reference.

According to an exemplary embodiment, accessory 172 may be forearm support 22, grip 122, or forearm support 156 so that the forearm support or grip may be used with conventional paint applicators (e.g., as a “universal” product). According to a preferred embodiment, the “forearm support” as accessory 172 is threadably coupled to the handle of a conventional paint applicator.

It is important to note that the term “paint” is intended to be a broad term and not a term of limitation. “Paint” as used in this disclosure may include, without limitation, any of a variety of liquids such as adhesive, tar, varnish, stain, shellac, water, primer, etc. The applicator may be used with any of a variety of liquids, tacky surface rollers, texture applicator, etc.

It is also important to note that the term “applicator” is intended to be a broad term and not a tem of limitation. “Applicator” as used in this disclosure may include, without limitation, any of a variety of apparatuses or devices configured to apply a liquid using manual, or “automatic” or “powered” equipment to replenish the “applying member” with liquid (e.g., from a reservoir using a pump or the like). “Applicator” includes roller-type devices, brushes, sprayers, and the like.

It is also important to note that the construction and arrangement of the elements of the forearm support for paint applicator as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, the forearm support may be moved between the stowed and deployed position by pivoting, sliding, removing, and the like. The forearm support surface may be made from any of a variety of rigid or pliable or deformable materials. Additionally, components of the applicator may be constructed of any of a variety of polymers, metal composites, metal alloys, and the like. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

What is claimed is:

1. A paint applicator comprising:
an applicator frame;
an applying medium coupled to the applicator frame;
a support coupled to the applicator frame adapted to fit against a forearm of a user.

2. The paint applicator of claim 1 wherein the support is configured to move between a deployed position and a stowed portion.

3. The paint applicator of claim 2 wherein the support is pivotally coupled to the frame.

4. The paint applicator of claim 2 wherein the support is pivotally coupled to the handle.

5. The paint applicator of claim 4 wherein the handle is contoured to secure the support in the deployed position.

6. The paint applicator of claim 5 wherein the handle includes a first set of bumps and a second set of bumps, and the support includes a pair of arms configured to be disposed between the first set of bumps and the second set of bumps when in the deployed position.

7. The paint applicator of claim 6 wherein the second set of bumps are configured to prevent further rotation of the pivot member.

8. The paint applicator of claim 2 wherein the support includes a support frame and a web.

9. The paint applicator of claim 5 wherein the support frame includes a first arm and a second arm coupled to the applicator frame.

10. The paint applicator of claim 9 wherein the web includes a forearm engagement surface coupled to the first arm and the end arm.

11. The paint applicator of claim 2 wherein the support is coupled to a hinge mechanism.

12. The paint applicator of claim 11 wherein the hinge mechanism includes a pair of ears extending from the frame, and a pivot member secured to the support and rotatably coupled to the pair of ears.

13. The paint applicator of claim 12 wherein the pivot member includes a stop surface configured to prevent further rotation of the pivot member.

14. A paint applicator comprising:
an applicator frame;
an applying medium coupled to the applicator frame;
a support coupled to the frame adapted to fit against a forearm of a user, and configured to be moved between a first position and a second position.

15. The paint applicator of claim 14 wherein the support includes a hinge mechanism coupled to the frame.

16. The paint applicator of claim 15 wherein the hinge mechanism includes ears extending from the handle, and a pivot member pivotally coupled to the ears and the forearm support.

17. The paint applicator of claim 16 wherein the pivot member includes a stop configured to prevent further rotation of the pivot member when the forearm support has been pivoted to the deployed position.

18. The paint applicator of claim 14 wherein the handle includes at least one aperture configured to receive a portion of the forearm support.

19. The paint applicator of claim 14 wherein the forearm support includes a support frame, the support frame including bars with ends received within the apertures in the handle.

20. The paint applicator of claim 14 wherein the support frame is removably coupled to the handle.

21. The paint applicator of claim 14 wherein the first position is a stowed position and the second position is a deployed position.

22. The paint applicator of claim 14 wherein the support is configured to pivot between the first position and the second position.

23. The paint applicator of claim 23 further including a pivotal coupling coupled to the support and the handle.

24. The paint applicator of claim 14 wherein the handle is contoured to secure the support in the deployed position.

25. The paint applicator of claim 24 wherein the handle includes a first set of bumps and a second set of bumps, and the support includes a pair of arms configured to be disposed between the first set of bumps and the second set of bumps when in the deployed position.

26. The paint applicator of claim 25 wherein the second set of bumps are configured to prevent further rotation of the pivot member.

27. The paint applicator of claim 14 wherein the support includes a support frame and a web.

28. A paint applicator comprising:
an applicator frame;
an applying medium coupled to the applicator frame;
a support means for leveraging against a forearm of a user;
a hinge mechanism coupling the support to the handle and configured move the support between a first position and a second position.

29. The paint applicator of claim 28 wherein the hinge mechanism includes:
ears extending from the handle; and
a pivot member pivotally coupled to the ears and the support means.

30. The paint applicator of claim 28 wherein the pivot member includes a stop configured to prevent further rotation of the pivot member when the support means has been pivoted to the second position.

31. The paint applicator of claim 28 wherein the support means includes a support frame, the support frame including bars with ends received within apertures in the handle.

32. The paint applicator of claim 28 wherein the support frame is removable from the handle.

33. The paint applicator of claim 28 wherein the handle is contoured to secure the support in the second position.

34. The paint applicator of claim 33 wherein the handle includes a first set of bumps and a second set of bumps, and the support includes a pair of arms configured to be disposed between the first set of bumps and the second set of bumps when in the deployed position.

35. The paint applicator of claim 34 wherein the second set of bumps are configured to prevent further rotation of the pivot member.

36. The paint applicator of claim 28 wherein the handle includes a bore configured to receive an accessory.

37. The paint applicator of claim 28 wherein the applicator frame is configured to be telescopically adjustable along an axis.

38. The paint applicator of claim 37 wherein the handle includes:
a first tube;
a second tube releasably coupled to the first tube in a plurality of positions.

39. The paint applicator of claim 38 wherein the handle includes a mechanism releasably retaining the first tube and the second tube relative to one another.

40. The paint applicator of claim 38 wherein the second tube is sized to receive the first tube.

41. The paint applicator of claim 38 wherein the second tube includes a plurality of openings, and the push pin mechanism includes a pin resiliently biased through a selected opening.
